(19) United States
(12) Patent Application Publication
(10) Pub. No.: US 2017/0171571 A1
(43) Pub. Date: Jun. 15, 2017

(54) Push Video Documentation Methods and Appliances

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Xiang QU, Beijing (CN)

(21) Appl. No.: 15/240,984

(22) Filed: Aug. 18, 2016

Related U.S. Application Data
(63) Continuation of application No. PCT/CN2016/088939, filed on Jul. 6, 2016.

(30) Foreign Application Priority Data
Dec. 11, 2015 (CN) 201510921004.8

(51) Int. Cl. H04N 21/222; H04N 21/61; H04N 21/4627; H04N 21/41; H04L 29/12; H04N 21/254

(52) U.S. Cl. CPC H04N 21/2223; H04L 61/2038; H04N 21/2541; H04N 21/4627; H04N 21/4122; H04N 21/6125; H04L 67/26

(57) ABSTRACT

The present disclosure discloses a method for pushing a video file, which is applied to a network server and includes following steps: acquiring a push request from a smart terminal including identification information of the smart terminal and a projection device; binding the smart terminal and the projection device if the identification information of the smart terminal is determined to be matched with that of the projection device; and acquiring push information from the smart terminal and pushing a video file designated by the push information to the projection device. In a method and electronic device for pushing a video file provided by the present disclosure, by establishing a network connection between a smart terminal and a projection device, the smart terminal may push, at any time and any place, a video file to the projection device by a network server, thereby timely implementing sharing or pre-storage of the video file, providing a function for sharing a video and reducing time in video buffering.

### CROSS REFERENCE TO RELATED APPLICATION

This application is a continuation of International PCT Patent Application No. PCT/CN2016/088939, filed Jul. 6, 2016 (attached hereto as an Appendix), and claims benefit/priority of Chinese patent application No. 201510921004.8, filed with the State Intellectual Property Office of China on Dec. 11, 2015, which are all incorporated herein by reference in entirety.

### FIELD OF TECHNOLOGY

The present disclosure relates to the field of multimedia control, and in particular, to a method and electronic device for pushing a video file.

### BACKGROUND

With the development of computer technologies and network technologies, network connection and smart control are implemented for a growing number of household appliances. Particularly, Internet TVs that are increasingly popular recently may allow on-demand video files provided by video websites to be performed online by connecting Internet, such that the user may watch the newest programme on a large screen. Comparing with performing videos on demand by means of smart terminals such as computer and mobile phone, a smart television is larger in screen size and better in sound effect, and thus can provide better viewing experience.

However, an existing smart television generally implements local operation only by means of remote control device or touch screen, and is unable to interact with other smart terminals. If a video file of a smart terminal is pushed to the smart television to play, it is needed to find the video file in the smart television again, thus the operation is inconvenient. Particularly, the operation is even more difficult when a smart terminal and the smart television are in different places.

### SUMMARY

In view of this, an objective of the present disclosure is to provide a method and electronic device for remotely pushing a video file from a smart terminal to a projection device.

According to a first aspect of the present disclosure, the present disclosure provides, based on the foregoing objective, a method for pushing a video file, which is applied to a network server and includes:

acquiring a push request from a smart terminal including identification information of the smart terminal and a projection device;

binding the smart terminal and the projection device, if the identification information of the smart terminal is determined to be matched with the identification information of the projection device; and

acquiring push information from the smart terminal and pushing a video file designated by the push information to the projection device.

According to a second aspect of the present disclosure, there is provided a non-volatile computer storage medium which is stored with computer executable instructions, and the computer executable instructions are configured for performing any one of the above methods for pushing a video file.

According to a third aspect of the present disclosure, there is provided an electronic device including one or more processors and a memory, wherein, the memory is stored with instructions executable by the one or more processors, and the instructions are set to perform any one of the above methods for pushing a video file.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart of a method for pushing a video file according to an embodiment of the present disclosure;

FIG. 2 is a schematic flowchart of a method for pushing a video file according to another embodiment of the present disclosure;

FIG. 3 is a timing diagram of a method for pushing a video file according to still another embodiment of the present disclosure;

FIG. 4 is a system block diagram of a system for pushing a video file according to an embodiment of the present disclosure;

FIG. 5 is a module block diagram of a server for pushing a video file according to still another embodiment of the present disclosure; and

FIG. 6 is a schematic structure diagram of hardware of an electronic device for pushing a video file provided by an embodiment of the present disclosure.

### DETAILED DESCRIPTION

In order to make the objects, technical solutions and advantages of the present disclosure clearer, the present disclosure will be further described in detail below with reference to the embodiments and accompanying drawings.

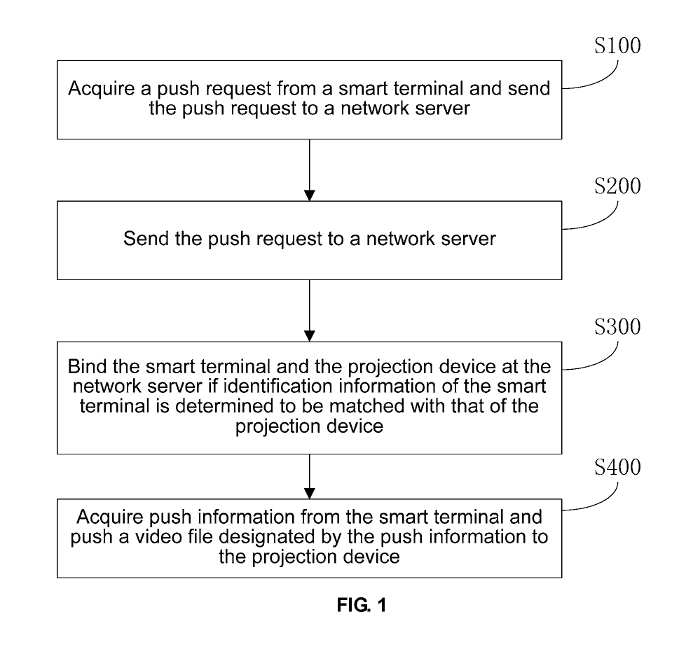

FIG. 1 is a schematic flowchart of a method for pushing a video file according to an embodiment of the present disclosure. As shown in FIG. 1, an embodiment of the present disclosure provides a method for pushing a video file to a projection device, which includes the following steps.

In step S100, a push request from a smart terminal including identification information of the smart terminal and the projection device is acquired.

The identification information includes user information and a network address, wherein the user information includes registration information for a user to log into the smart terminal and a playing device, and includes information such as a username or an email address which may be used as a basis of identity recognition.

The smart terminal is a smart device having a network connection function such as a computer, a smart phone or a tablet computer, and the projection device is a smart projection device having a network connection function such as a smart television or a network projector.

In step S200, the push request is sent to a network server.

Specifically, a sending approach includes a wireless data connection provided by a wireless service provider or a wired network connection provided by a broadband service provider.

In step S300, it is determined whether the identification information of the smart terminal is matched with the identification information of the projection device.

In step S301, the smart terminal and the projection device are bound at the network server if the identification information of the smart terminal is determined to be matched with the identification information of the projection device.

The binding means that when receiving a control instruction or behavior of pushing a video sent by the smart terminal, the network server directly pushes the control instruction or the video to the projection device bound with the network server without inquiring a target to the smart terminal. The binding function may be implemented by using a correspondence of physical addresses or a correspondence of usernames.

In step S400, push information is acquired from the smart terminal and a video file designated by the push information is pushed to the projection device. The “pushing” means that a user controls projection of the projection device or pre-stores a video that the user wants to watch by the smart terminal. Specific methods and steps are described in detail hereinafter.

In a further embodiment, before the step of acquiring a push request from a smart terminal including identification information of the smart terminal and the projection device, the step S100 further includes an implied step, namely, a step of acquiring the user information of the projection device by the smart terminal.

For example, after receiving a binding instruction, the projection device displays a two-dimensional code including the user information of the projection device, and the smart terminal scans the two-dimensional code to acquire the user information of the projection device and then adds the user information of the projection device into the identification information of the smart terminal, or acquires the user information of the projection device in other ways and then adds it into the identification information of the smart terminal. When the network server compares the identification information of the smart terminal with the identification information of the projection device, if the identification information of the projection device is found from identification information of a mobile terminal, it may be proved that the mobile terminal and the projection device are positioned within the same work space; in other words, if the user currently wants to directly control the projection device by means of the mobile terminal, the binding may be directly performed.

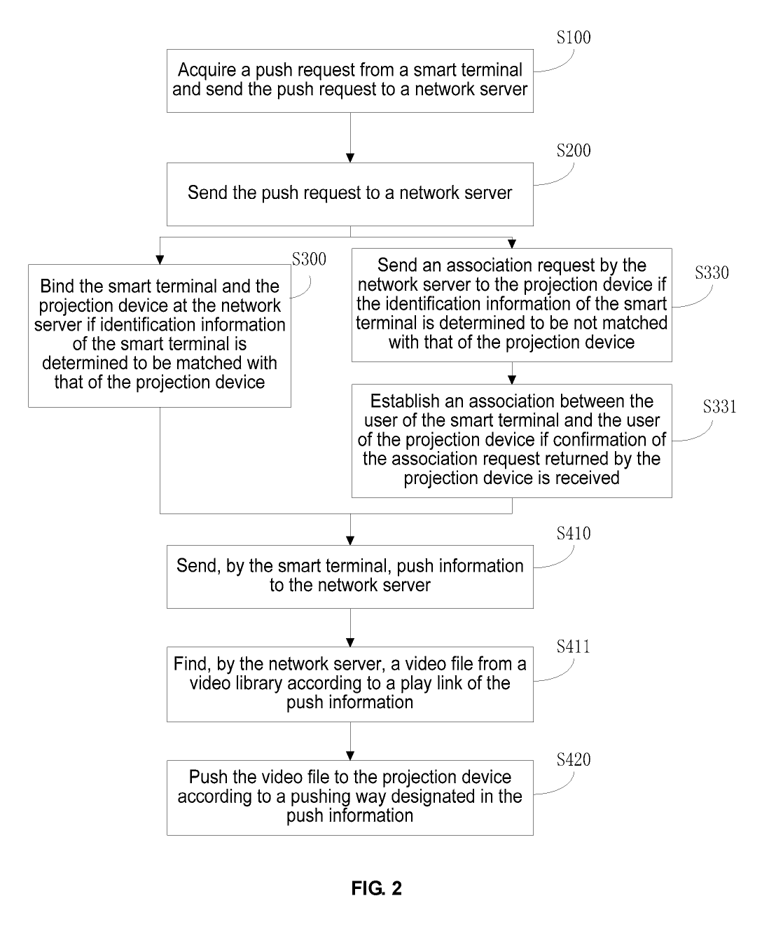

FIG. 2 is a schematic flowchart of a method for pushing a video file according to another embodiment of the present disclosure. Referring to FIG. 2, further, the step S300 of determining whether the identification information of the smart terminal is matched with the identification information of the projection device includes the following steps.

In step S310, the user information of the smart terminal is compared with the user information of the projection device.

In step S320, the network addresses of the smart terminal and the projection device are bound at the network server, if the user of the smart terminal and the user of the projection device are determined to be the associated users.

In some alternative embodiments, the associated users may be the same user or may be different users associated in the network server in advance.

For example, the user may simultaneously log into the smart terminal and the projection device by using own user account, and the server may automatically associate two devices into which the same user account is logged (however, the same user is unable to simultaneously log into two or more mobile terminals or projection devices) when performing an identification; or, the user may also associate two different accounts (for example, the user's own account and an account of the user's family member) in the server in advance, and a specific association way may be to establish an association table in the network server. An associated user corresponding to each user is recorded in the association table. When performing an identification, the server may automatically bind devices corresponding to two accounts as long as the two accounts are determined to be already associated.

Further, the method further includes step S330: sending an association request by the network server to the projection device if the identification information of the smart terminal is determined to be not matched with the identification information of the projection device.

In step S331, the network server establishes an association between the user of the smart terminal and the user of the projection device if receiving confirmation of the association request returned by the projection device.

The foregoing steps S330 and S331 implement a function of newly establishing, in the network server, an association relationship between the smart terminal and the projection device when the smart terminal is unable to be automatically bound with the projection device. Specifically, a way for establishing the association relationship may be to establish an association table for each user, and user information of all users between whom and the user an association relationship is established is recorded in the association table. Other similar methods may also be used as ways for establishing the association relationship as long as they can ensure that the network server can record the corresponding relationship between the two users.

Specifically, in an alternative embodiment, step S400 of pushing the video file from the smart terminal to the projection device includes the following steps.

In step S410, the smart terminal sends push information to the network server. The push information includes a pushing way, a play link of the video file and so on.

In step S411, the network server finds a corresponding video file from a video library according to the play link.

In step S420, the found video file is pushed to the projection device bound with the smart terminal.

The foregoing steps are relatively easy to be understood, in other words, the smart terminal is merely configured for pushing a play link, and the network server informs the projection device to perform downloading of the video file. Further, before pushing the video file to the projection device, the network server first sends a push request to the projection device; the projection device pops up a dialog box for inquiring contents including “whether to accept video push” in a display screen, wherein the dialog box also includes essential information of the video (for example, a video name, type, poster and so on); and when the user confirms to receive the push (a receive operation is executed by a remote control terminal or the like of a playing device), the network server further completes the pushing function. This embodiment is applicable to a case where a user who holds the smart terminal wants to remotely push a video file when the user is farther from the projection device. For example, the user wants to push a certain entertainment programme to a family member in other places, or the user wants to push a certain movie to a projection device of his/her home, or the like.

In another alternative embodiment, the step S400 of pushing the video file from the smart terminal to the projection device includes the following steps.

In step S430, the smart terminal finds the projection device in a local network. The local network is a civil short-distance network, including but not limited to a local area network established by a router, a Bluetooth connection and an infrared connection.

In step S440, a local connection between the smart terminal and the projection device is established when the projection device is found.

In step S450, the smart terminal pushes the video file to the projection device through a local connection.

Further, the step S450 of pushing the video file by the smart terminal to the projection device through a local connection includes the following steps.

In step S451, the smart terminal sends the play link of the video file to the projection device and the projection device acquires the video file from the network server according to the play link; or

In step S452, the smart terminal sends the downloaded video file to the projection device.

The foregoing steps S430-S450 provide a method for pushing a video through a local network. When the smart terminal and the projection device are positioned in the same local area network, a way of local pushing may be used to perform the operation, and a delay of the operation is lower than that by using a wide area network.

Further, in a preferred embodiment, the method of pushing through a wide area network and the method of pushing through a local network may be switched with each other. The smart terminal may sense in real time whether the projection device bound with the smart terminal is within its local area network. The push process may be automatically switched to the local push if the projection device is detected in the local area network. In this push process, it is unnecessary to send any reminding to the user, and the user will not sense any switching. In other words, “traceless switching” is implemented, and delay of the user's operation is reduced without other additional operations.

Further, the step S400 of acquiring push information from the smart terminal and pushing the video file designated by the push information to the projection device further includes the following step.

In step S460, the smart terminal sends a control instruction for controlling video playing to the projection device to control a process of video playing of the projection device.

Specifically, the foregoing control instruction is used to control, including but not limited to, volume, video progress, starting of playing, pausing of playing, switching of video, displaying of poster, adding of comment, and so on.

In a preferred embodiment, when the projection device plays a pushed video file, the smart terminal simultaneously starts to play the video file. An operation of a playing process of the video file on the smart terminal is copied onto the projection device so that video playing of the projection device is synchronous with that of the smart terminal.

Further, in the step S400 of acquiring push information from the smart terminal and pushing a video file designated by the push information to the projection device, a pushing way is determined in the push information of the smart terminal, and the pushing way includes immediate playing and cache playing.

The immediate playing means that the projection device immediately plays the video file. Alternatively, before playing the video file, the projection device may receive a prompt whether to play a video file pushed by a certain user, and plays the video file after the projection device sends a confirmation to the network server.

The cache playing means that the projection device caches the video file in a local memory and plays the video file when receiving a playing instruction.

Two different pushing ways are provided above. The way of immediate playing may push a video file to the projection device in real time and may implement basically synchronous video playing of the smart terminal and the projection device. The way of cache playing may allow a user to remotely control the projection device to download a video file in advance and play the video file when the user can contact the projection device, thereby saving time in loading the video file. Particularly, some high-definition video files whose bit rates are higher may be stuck generally when they are loaded in a low network bandwidth environment, thereby having a negative effect on viewing effect. However, the cache playing may effectively solve this problem.

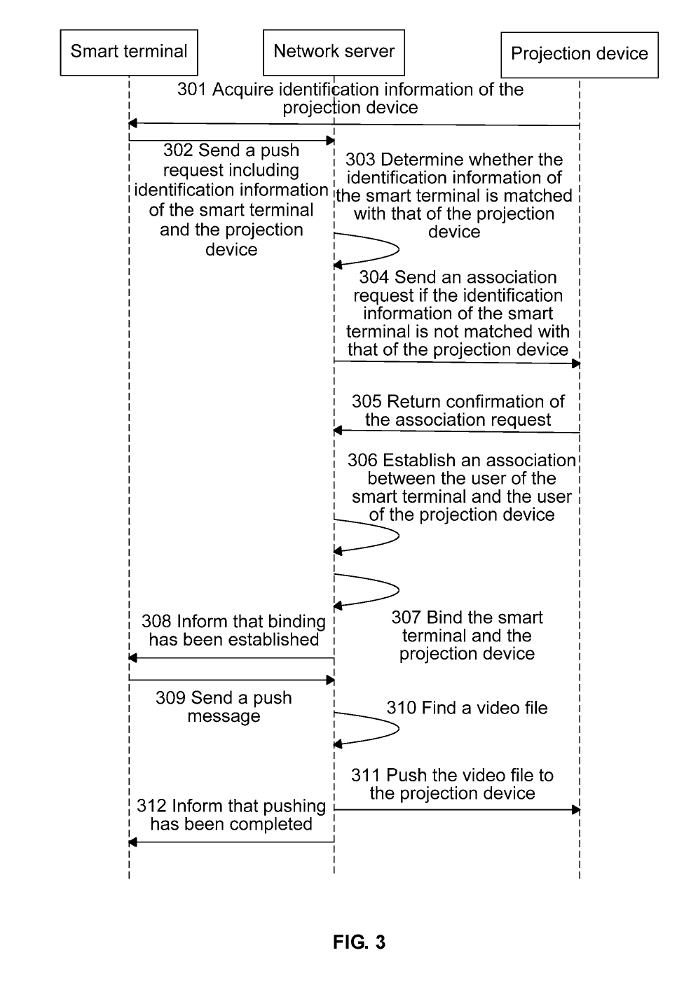

FIG. 3 is a timing diagram of a method for pushing a video file according to still another embodiment of the present disclosure. As shown in FIG. 3, the method includes following timing steps.

In step S301, the smart terminal acquires identification information of the projection device.

In step S302, the smart terminal sends a push request including identification information of the smart terminal and the projection device to the network server.

In step S303, the network server determines whether the identification information of the smart terminal is matched with the identification information of the projection device. If the identification information of the smart terminal is determined to be matched with the identification information of the projection device, it is jumped to step S307.

In step S304, the network server sends an association request to the projection device when the identification information of the smart terminal is determined to be not matched with the identification information of the projection device.

In step S305, the projection device returns a confirmation of the association request to the network server.

In step S306, the network server establishes an association between the user of the smart terminal and the user of the projection device.

In step S307, the smart terminal and the projection device is bound.

In step S308, the network server informs that binding has been established between the smart terminal and the projection device.

In step S309, the smart terminal sends a push message to the network server.

In step S310, the network server finds a video file according to the push message.

In step S311, the network server pushes the video file to the projection device.

In step S312, the network server informs the smart terminal that the pushing has been completed.

Through the above steps, the smart terminal may push a video to a projection device in different places via a wide area network.

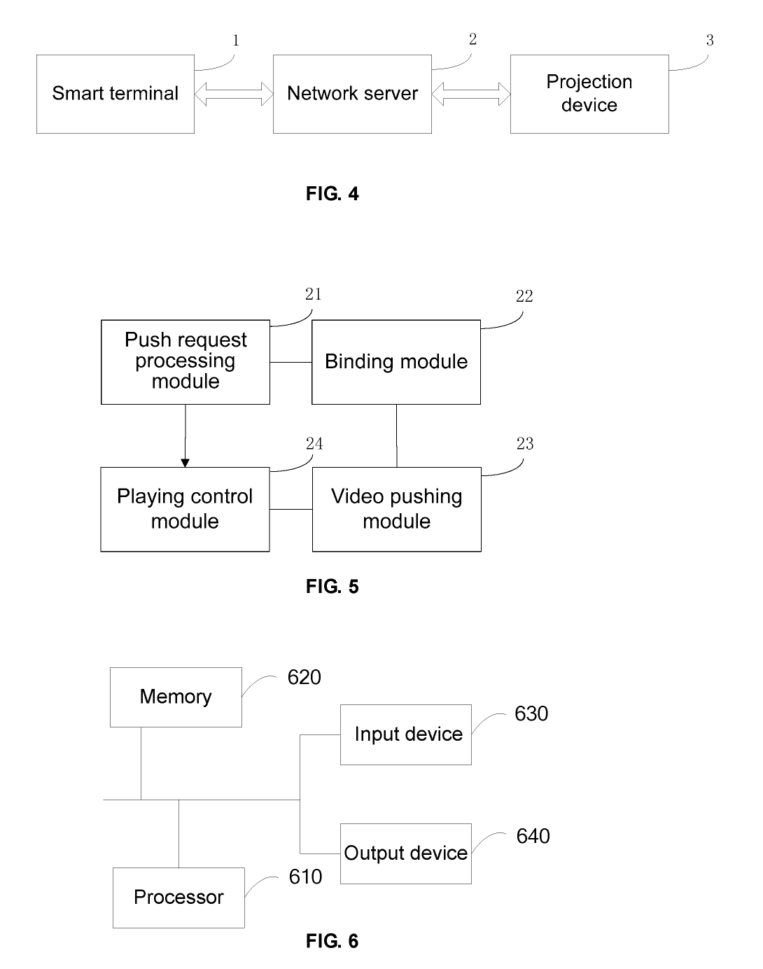

FIG. 4 is a system block diagram of a system for pushing a video file according to an embodiment of the present disclosure. As shown in FIG. 4, the system for pushing a video file according to an embodiment of the present disclosure includes a smart terminal 1, a network server 2 and a projection device 3.

The smart terminal 1 is configured for acquiring identification information of a projection device and identification information of the smart terminal, sending a push request including the identification information of the smart terminal and the identification information of the projection device to a network server, and sending push information including a video file link to the network server 2.

The network server 2 is configured for comparing the identification information of the smart terminal 1 with the identification information of the projection device 3, binding the smart terminal 1 and the projection device 3 if the identification information of the smart terminal 1 is determined to be matched with the identification information of the projection device 3, and pushing a video file to the projection device 3 according to the push information.

The projection device 3 is configured for receiving and playing the video file pushed by the network server 2.

In some alternative embodiments, the identification information includes user information and a network address. The network server 2 is configured for comparing the user information of the smart terminal 1 with the user information of the projection device 3 to determine whether a user of the smart terminal 1 and a user of the projection device 3 are associated users. The associated users may be the same user who respectively logs into the smart terminal 1 and the projection device 3, or the associated users may be different users associated in the network server 2 in advance.

The network server 2 is configured for binding the network addresses of the smart terminal 1 and the projection device 3 if the user of the smart terminal 1 and the user of the projection device 3 are determined to be the associated users.

In another embodiment, the network server 2 is configured for sending an association request to the projection device 3 if the identification information of the smart terminal 1 is determined to be not matched with the identification information of the projection device 3.

The network server 2 is further configured for establishing an association between the user of the smart terminal 1 and the user of the projection device 3 if receiving confirmation of the association request returned by the projection device 3.

In an embodiment, the smart terminal 1 is configured for sending a play link of the video file to the network server 2, and the network server 2 is configured for pushing the video file to the projection device 3 bound with the smart terminal 1 according to the play link.

In another alternative embodiment, the smart terminal 1 is configured for sending a control instruction for controlling video playing to the projection device 3 to control a process of video playing of the projection device 3.

Further, when the video file is pushed from the smart terminal 1 to the projection device 3, a pushing way is determined in the push information of the smart terminal 1, and the pushing way includes immediate playing and cache playing.

The immediate playing means that the projection device 3 immediately plays the video file.

The cache playing means that the projection device 3 caches the video file in a local memory and plays the video file when receiving a playing instruction.

Another embodiment of the present disclosure provides a method for pushing a video file, which is applied to a network server and includes following steps:

acquiring a push request from a smart terminal including identification information of the smart terminal and a projection device;

binding the smart terminal and the projection device if the identification information of the smart terminal is determined to be matched with the identification information of the projection device; and

acquiring push information from the smart terminal and pushing a video file designated by the push information to the projection device.

In another embodiment, the identification information includes user information and a network address; and the step of binding the smart terminal and the projection device if the identification information of the smart terminal is determined to be matched with the identification information of the projection device includes:

comparing the user information of the smart terminal with the user information of the projection device to determine whether a user of the smart terminal and a user of the projection device are associated users; wherein the associated users are the same user who respectively logs into the smart terminal and the projection device; or the associated users are different users associated in the network server in advance; and

binding the network addresses of the smart terminal and the projection device if the user of the smart terminal and the user of the projection device are determined to be the associated users.

In a preferred embodiment, after the step of acquiring a push request and sending the push request to the network server, the method further includes:

sending an association request to the projection device if the identification information of the smart terminal is determined to be not matched with the identification information of the projection device; and

establishing an association between the user of the smart terminal and the user of the projection device if confirmation of the association request returned by the projection device is received.

In a preferred embodiment, the step of pushing the video file from the smart terminal to the projection device includes:

acquiring a play link of the video file from the smart terminal; and

pushing the video file to the projection device bound with the smart terminal according to the play link.

In an alternative embodiment, the step of pushing the video file from the smart terminal to the projection device further includes:

acquiring a control instruction for controlling video playing from the smart terminal, and sending the control instruction to the projection device to control a process of video playing of the projection device.

In another embodiment, a video file designated by the push information is pushed to the projection device, and a pushing way is determined in the push information of the smart terminal. The pushing way includes immediate playing and cache playing.

The immediate playing means that the projection device immediately plays the video file.

The cache playing means that the projection device caches the video file in a local memory and plays the video file when receiving a playing instruction.

FIG. 5 is a module block diagram of a server for pushing a video file according to still another embodiment of the present disclosure. As shown in FIG. 5, another embodiment of the present disclosure provides a server for pushing a video file, which includes: a push request processing module 21, a binding module 22, and a video pushing module 23.

The push request processing module 21 is configured for acquiring a push request from a smart terminal including identification information of the smart terminal and a projection device.

The binding module 22 is configured for determining whether the identification information of the smart terminal is matched with that of the projection device, and binding the smart terminal and the projection device if the identification information of the smart terminal is matched with the identification information of the projection device.

The video pushing module 23 is configured for acquiring push information from the smart terminal and pushing a video file designated by the push information to the projection device.

In an alternative embodiment, the identification information includes user information and a network address. The binding module 22 is further configured for comparing the user information of the smart terminal with the user information of the projection device to determine whether a user of the smart terminal and a user of the projection device are associated users. The associated users may be the same user who respectively logs into the smart terminal and the projection device; or the associated users may be different users associated in the network server in advance. The binding module 22 is configured for binding the network addresses of the smart terminal and the projection device if the user of the smart terminal and the user of the projection device are determined to be the associated users.

In a preferred embodiment, the binding module 22 is further configured for sending an association request to the projection device if the identification information of the smart terminal is determined to be not matched with the identification information of the projection device. The binding module is configured for establishing an association between the user of the smart terminal and the user of the projection device if receiving confirmation of the association request returned by the projection device.

In another embodiment, the video pushing module 21 is configured for acquiring a play link of the video file from the smart terminal, and pushing the video file to the projection device bound with the smart terminal according to the play link.

In an alternative embodiment, the server further includes a playing control module 24.

The playing control module 24 is configured for acquiring a control instruction for controlling video playing from the smart terminal, and sending the control instruction to the projection device to control a process of video playing of the projection device.

In another embodiment, a way for pushing a video file by the video pushing module 23 are determined in the push information of the smart terminal, and the pushing way includes immediate playing and cache playing.

The immediate playing means that the projection device immediately plays the video file.

The cache playing means that the projection device caches the video file in a local memory and plays the video file when receiving a playing instruction.

An embodiment of the present disclosure further provide a non-volatile computer storage medium, wherein the non-volatile computer storage medium is stored with computer executable instructions which are used to perform any of the methods for pushing a video file in the above embodiments.

FIG. 6 is a schematic structure diagram of hardware of an electronic device for pushing a video file according to an embodiment of the present disclosure. As shown in FIG. 6, the device includes one or more processors 610 and a memory 620, and FIG. 6 illustrates one processor 610 as an example.

The electronic device for pushing a video file may further include an input device 630 and an output device 640.

The processor 610, memory 620, input device 630 and output device 640 may be connected with each other through bus or other ways. FIG. 6 illustrates bus connection as an example.

As a non-volatile computer readable storage medium, the memory 620 may be configured to store non-volatile software program, non-volatile computer executable program and module, such as program instruction/module (for example, the push request processing module 21, the binding module 22, the video pushing module 23 and the playing control module 24 shown in FIG. 5) corresponding to the method for pushing a video file according to the embodiments of the disclosure. By executing the non-volatile software program, instruction and module stored in the memory 620, the processor 610 may perform various functional applications of the server and data processing, that is, achieve the method for pushing a video file according to the above mentioned embodiments.

The memory 620 may include a program storage area and a data storage area, wherein the program storage area may store the operating system and application which are needed by at least one function, and the data storage area may store data which is created according to use of the device for pushing a video file, and the like. Further, the memory 620 may include a high-speed random access memory, and may further include a non-volatile memory, such as at least one of disk memory device, flash memory device or other types of non-volatile solid state memory device. In some embodiments, optionally, the memory 620 may include a memory provided remotely with respect to the processor 610, and such memory may be connected with the device for pushing a video file through network. The examples of the network may include but not limited to Internet, intranet, LAN (Local Area Network), mobile communication network and combinations thereof.

The input device 630 may receive inputted digital or character information, and generate key signal input related to the user settings and functional control of the device for pushing a video file. The output device 640 may include a display device such as a display screen and the like.

The above one or more modules may be stored in the memory 620. When these modules are executed by the one or more processor 610, the method for pushing a video file according to any one of the above embodiments may be performed.

The above product may perform the methods provided in the embodiments of the disclosure, and include functional modules corresponding to these methods and advantageous effects. Further technical details which are not described in detail in the present embodiment may refer to the methods provided according to embodiments of the disclosure.

The electronic device in the embodiment of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID, UMPC devices and the like, such as iPad;

(3) portable entertainment device, which can display and play multimedia contents, and includes audio or video player (such as iPod), portable game console, e-book and smart toys and portable vehicle navigation device;

(4) server, which is an device for providing computing service, and constituted by processor, hard disc, memory, system bus and the like, wherein the server has a framework similar to that of a computer, but is demanded for superior processing ability, stability, reliability, security, extendibility and manageability due to high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in a place or distributed to a plurality of network units. All or part of modules may be selected as actually required to implement the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk, compact disc and the like, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for, which is applied to a network server, comprising:
acquiring a push request from a smart terminal comprising identification information of the smart terminal and a projection device;
binding the smart terminal and the projection device, if the identification information of the smart terminal is determined to be matched with the identification information of the projection device; and
acquiring push information from the smart terminal and pushing a video file designated by the push information to the projection device.

2. The method according to claim 1, wherein the identification information comprises user information and a network address; and the step of binding the smart terminal and the projection device if the identification information of the smart terminal is determined to be matched with the identification information of the projection device comprises:
comparing the user information of the smart terminal with the user information of the projection device to determine whether a user of the smart terminal and a user of the projection device are associated users, wherein the associated users are users whose user information is identical or is associated in the network server in advance; and
binding the network addresses of the smart terminal and the projection device, if the user of the smart terminal and the user of the projection device are determined to be the associated users.

3. The method according to claim 2, wherein the method further comprises:
sending an association request to the projection device, if the identification information of the smart terminal is determined to be not matched with the identification information of the projection device; and
establishing an association between the user of the smart terminal and the user of the projection device, if confirmation of the association request returned by the projection device is received.

4. The method according to claim 1, wherein the step of pushing a video file designated by the push information to the projection device comprises:
acquiring a play link of the video file from the push information; and
pushing the video file to the projection device bound with the smart terminal according to the play link.

5. The method according to claim 1, wherein the step of pushing the video file from the smart terminal to the projection device further comprises:
acquiring a control instruction for controlling video playing from the smart terminal, and sending the control instruction to the projection device to control a process of video playing of the projection device.

6. A non-transitory computer-readable storage medium, which stores computer-executable instructions that, when executed by an electronic device, cause the electronic device to:
acquire a push request from a smart terminal comprising identification information of the smart terminal and a projection device;
bind the smart terminal and the projection device, if the identification information of the smart terminal is determined to be matched with the identification information of the projection device; and
acquire push information from the smart terminal and push a video file designated by the push information to the projection device.

7. The non-transitory computer-readable storage medium according to claim 6, wherein the identification information comprises user information and a network address; and the step of binding the smart terminal and the projection device if the identification information of the smart terminal is determined to be matched with the identification information of the projection device comprises:
comparing the user information of the smart terminal with the user information of the projection device to determine whether a user of the smart terminal and a user of the projection device are associated users, wherein the associated users are users whose user information is identical or is associated in the network server in advance; and
binding the network addresses of the smart terminal and the projection device, if the user of the smart terminal and the user of the projection device are determined to be the associated users.

8. The non-transitory computer-readable storage medium according to claim 7, wherein the executable instructions are configured to:
send an association request to the projection device, if the identification information of the smart terminal is determined to be not matched with the identification information of the projection device; and
establish an association between the user of the smart terminal and the user of the projection device, if confirmation of the association request returned by the projection device is received.

9. The non-transitory computer-readable storage medium according to claim 6, wherein the step of pushing a video file designated by the push information to the projection device comprises:
acquiring a play link of the video file from the push information; and
pushing the video file to the projection device bound with the smart terminal according to the play link.

10. The non-transitory computer-readable storage medium according to claim 6, wherein the step of pushing the video file from the smart terminal to the projection device further comprises:
acquiring a control instruction for controlling video playing from the smart terminal, and sending the control instruction to the projection device to control a process of video playing of the projection device.

11. An electronic device, comprising:
at least one processor; and
a memory communicably connected with the at least one processor,
wherein the memory is stored with instructions executable by the at least one processor, and the instructions are executed by the at least one processor to cause the at least one processor to:
acquire a push request from a smart terminal comprising identification information of the smart terminal and a projection device;
bind the smart terminal and the projection device, if the identification information of the smart terminal is determined to be matched with the identification information of the projection device; and
acquire push information from the smart terminal and push a video file designated by the push information to the projection device.

12. The electronic device according to claim 11, wherein the identification information comprises user information and a network address; and the step of binding the smart terminal and the projection device if the identification information of the smart terminal is determined to be matched with the identification information of the projection device comprises:
comparing the user information of the smart terminal with the user information of the projection device to determine whether a user of the smart terminal and a user of the projection device are associated users, wherein the associated users are users whose user information is identical or is associated in the network server in advance; and
binding the network addresses of the smart terminal and the projection device, if the user of the smart terminal and the user of the projection device are determined to be the associated users.

13. The electronic device according to claim 12, wherein the at least one processor is further caused to:
send an association request to the projection device, if the identification information of the smart terminal is determined to be not matched with the identification information of the projection device; and
establish an association between the user of the smart terminal and the user of the projection device, if confirmation of the association request returned by the projection device is received.

14. The electronic device according to claim 11, wherein the step of pushing a video file designated by the push information to the projection device comprises:
acquiring a play link of the video file from the push information; and
pushing the video file to the projection device bound with the smart terminal according to the play link.

15. The electronic device according to claim 11, wherein the step of pushing the video file from the smart terminal to the projection device further comprises:
acquiring a control instruction for controlling video playing from the smart terminal, and sending the control instruction to the projection device to control a process of video playing of the projection device.
